(19) United States
(12) Patent Application Publication
(10) Pub. No.: US 2005/0253564 A1
(43) Pub. Date: Nov. 17, 2005

(54) Active power filter apparatus with reduced va rating for neutral current suppression

(76) Inventor: Se-wan Choi, Seoul (KR)

Correspondence Address: CANTOR COLBURN, LLP, 55 GRIFFIN ROAD SOUTH, BLOOMFIELD, CT, 06002, US

(21) Appl. No.: 10/521,148

(22) PCT Filed: Jan. 2, 2003
(86) PCT No.: PCT/KR03/00001

§ 371 Date: Jan. 13, 2005

(30) Foreign Application Priority Data
Jul. 19, 2002 (KR) 10-2002-0042275

(51) Int. Cl. G05F 1/70

(52) U.S. Cl. 323/207

(57) ABSTRACT

Disclosed is an active power filter with a reduced VA rating for reducing harmonic currents in a neutral line in a three-phase four-line power system. An inverter is connected to the neutral line for PWM-controlling current flow of the neutral line based on a voltage control signal from a controller so that a fundamental component of a load-side neutral current flows to the three-phase AC power source and its harmonic component is circulated to the load. A transformer is connected between the neutral line and each phase line of the three-phase AC power source for forming a current path whereby the harmonic component flows to the load through the phase line. A rectifier is connected between the transformer and the inverter for rectifying drive voltage into DC voltage and applying it to the inverter.

### TECHNICAL FIELD

The present invention relates to an active power filter apparatus for reducing harmonic currents in a neutral line, and more particularly to an active power filter apparatus which can effectively reduce harmonic currents occurring in a neutral line of a three-phase four-line power transducer system, and also reduce the VA rating of an internal inverter.

### BACKGROUND ART

In recent times, nonlinear loads such as a computer device, a UPS (Uninterruptible Power Supply), a rectifier, a lighting device, office equipment, etc., are increasingly used in low-voltage three-phase four-line distribution system of office and residential buildings, manufacturing plants, etc. Use of the nonlinear loads causes each phase current to be non-sinusoidal, whereby triplen-harmonic neutral currents such as 3rd, 9th, 15th harmonics, etc., excessively flow even when balanced loads are provided.

Such excessive neutral currents cause many considerable problems such as a malfunction of the neutral line, overheating of a transformer, and a voltage drop between the neutral line and ground. Such problems resulting from excessive neutral currents are illustrated in the following Table 1.

TABLE 1

| POSITIONS | PROBLEMS |
|---|---|
| Neutral Line | Overheating, malfunction, and fire due to |
| | excessive current |
| Transformer | Overload, overheating, and dielectric breakdown |
| Breaker/Relay | Frequent tripping and mis-operation |
| Elements in System | Damage from overload of neutral current |
| Meter | Mis-operation due to voltage drop between neutral |
| | and ground points |
| Cable | Overheating of phase conductor due to overheating |
| | of neutral line |
| Cabinet Panel | Electric Noise |

Various methods have been proposed to reduce the excessive neutral current. One proposed method is to connect a zigzag transformer to the neutral and phase lines of the conventional three-phase power supply (P. P. Khera, “Application of Zigzag Transformers for Reducing Harmonics in the Neutral Conductor of Low Voltage Distribution System”, IEEE IAS conf. Rec, 1990, pp. 1092). This prior art aims to remove the harmonic components of neutral currents flowing into the power supply by circulating the zero phase component of triplen harmonic currents generated from loads by means of the zigzag transformer. However, this prior art has problems in that the efficiency of removing neutral current is affected by system impedance, and a specially-designed transformer is needed in order to reduce an impedance of the zero phase component, thereby increasing the size of the transformer.

In addition, a three-phase four-line active power filter has been proposed to compensate for each phase current's harmonics as well as the neutral current without being affected by system impedance (C. A. Quinn, N. Mohan, “Active Filtering of Harmonic Currents in Three-Phase, Four-Line Systems with Three-Phase and Single-Phase Non-Linear Loads”, in APEC 1992, pp. 829-835). However, because of a complicated control operation, a higher capacity of the active power filter with respect to load capacity, and a higher manufacturing cost, this active power filter has failed to gain wide acceptance, while being limited for use in some important loads.

In order to overcome the problems in the two prior arts, an active power filter for canceling neutral current harmonics has been proposed to decrease the size of the transformer and reduce manufacturing costs (P. N. Enjeti. W. Shiren, “Analysis and Design of a New Active Power Filer to Cancel Neutral Current Harmonics in Three-Phase Four-Line Electric Distribution Systems”, IEEE Trans. Ind. Appl., vol. 30, no 6, November/December 1994, pp. 1565-1572). However, this prior art also has a problem in that the voltage and current ratings of an inverter provided in the filter are high.

### DISCLOSURE OF THE INVENTION

Therefore, the present invention has been made in view of the above problems, and it is an object of the present invention to provide an active power filter apparatus with a reduced VA rating for removing neutral currents whereby it is possible to effectively reduce harmonic currents occurring in a neutral line of a three-phase four-line power transducer system and also to reduce the voltage and current ratings of an internal inverter with respect to load capacities.

In accordance with the present invention, the above and other objects can be accomplished by the provision of an active power filter apparatus with a reduced VA rating for reducing harmonic currents generated in a neutral line connected between a load and a three-phase AC power source in a three-phase four-line power distribution system, the apparatus comprising:
an inverter unit connected in series with the neutral line for controlling current flow of the neutral line based on a predetermined voltage control signal so that a fundamental component of a load-side neutral current flows to the three-phase AC power source and a harmonic component of the load-side neutral current is circulated to the load;
a transformer connected between the neutral line and each phase line of the three-phase AC power source for forming a current path which allows the harmonic component of the load-side neutral current to flow to the load through the phase line;
a rectifier unit connected between the transformer and the inverter unit for rectifying a predetermined drive voltage, supplied to the transformer, into a DC voltage and applying the rectified DC voltage to the inverter unit; and
a controller for generating the voltage control signal for use in controlling a PWM operation of the inverter unit based on a first small signal of the load-side neutral current and a second small signal of the power-source-side neutral current, which are extracted from the neutral line.

According to such a configuration of the present invention, it is possible to reduce the voltage and current ratings of the internal inverter with respect to the load capacity as well as effectively suppress the harmonic currents generated in the neutral line.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the circuit configuration of an active power filter apparatus with a reduced VA rating for removing neutral currents according to an embodiment of the present invention;

FIG. 2 is a functional block diagram showing the configuration of a closed-loop control system according to the present invention;

FIG. 3 is a view showing compensation characteristics of the active power filter according to the closed-loop control system of FIG. 2;

FIG. 4 is a waveform view showing simulation results of the active power filter apparatus with a reduced VA rating for reducing neutral currents, according to the present invention, in the case where the load is balanced;

FIG. 5 is a waveform view showing simulation results of the active power filter apparatus with a reduced VA rating for reducing neutral currents, according to the present invention, in the case where the load is unbalanced;

FIGS. 6a to 6c are views showing frequency spectrums of a load-side neutral current, a power-source-side neutral current, and a harmonic current to be circulated to the load through a zigzag transformer of FIG. 1, respectively, when the load is unbalanced; and

FIG. 7 is a view showing the circuit configuration of an active power filter device with a reduced VA rating for removing neutral currents, according to another embodiment of the present invention.

### BEST MODE FOR CARRYING OUT THE INVENTION

Now, embodiments according to the present invention are described in detail referring to the drawings.

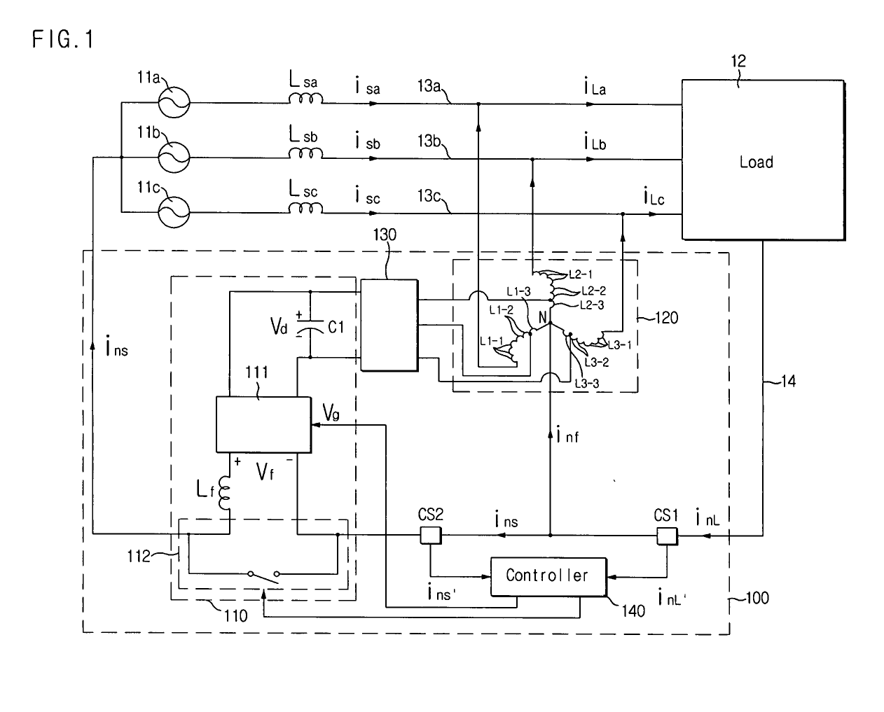

FIG. 1 is a view showing the circuit configuration of an active power filter apparatus with a reduced VA rating for removing neutral currents according to an embodiment of the present invention.

In FIG. 1, reference numerals 11a, 11b, and 11c denote three phase AC power sources which provide three AC powers having the same voltage and being out of phase with each other by 120 degrees. Reference numeral 12 denotes a load, particularly a nonlinear load, such as a rectifier, a lighting device, and office equipment. Reference numerals 13a, 13b, and 13c denote phase lines connected between the three phase AC power sources 11a, 11b, and 11c and the load 12. Reference numeral 14 denotes a neutral line connected between the load 12 and the three phase power sources 11a, 11b, and 11c. Reference symbols is iₛₐ, i_{sb}, and i_{sc} denote power-source-side phase currents, reference symbols i_{La}, i_{Lb}, and i_{Lc} denote load-side phase currents, and Lₛₐ, L_{sb}, and L_{sc} denote power source impedance components of the three phase AC power sources 11a, 11b, and 11c.

As shown in FIG. 1, the three phase AC power sources 11a, 11b, and 11c, the load 12, the phase lines 13a, 13b, and 13c, the neutral line 14, and the impedance components Lₛₐ, L_{sb}, and L_{sc} constitute a general three-phase four-line power distribution system.

In FIG. 1, reference numeral 100 denotes an active power filter according to the embodiment of the present invention, which includes an inverter unit 110, a zigzag transformer 120, a rectifier unit 130, first and second current sensors CS1 and CS2, and a controller 140.

The inverter unit 110 is connected in series with the neutral line 14 and functions to control the flow of the currents in the neutral line 14 in the following manner. Based on a predetermined voltage control signal V_{g} provided by a controller 140, the fundamental component of the load-side neutral current i_{lL} flows into the three phase AC power sources 11a, 11b, and 11c, whereas the harmonic components (particularly, triplen-harmonic currents such as 3rd, 9th, 15th harmonics, etc.,) of the load-side neutral current i_{nL} do not flow into the three phase AC power sources 11a, 11b, and 11c, but are circulated to the load 12 by the zigzag transformer 120.

As shown in FIG. 1, the inverter unit 110 includes a smoothing capacitor C1, a single-phase full-wave inverter circuit 111, a ripple-removing inductor L_{f}, and a bypass switch 112.

The smoothing capacitor functions to smooth a predetermined DC drive voltage V_{d} supplied from center taps n1, n2, and n3 of the zigzag transformer 120 through the rectifier unit 130. The single-phase full-wave inverter circuit 111 operates in a PWM (Pulse Width Modulation) manner based on the voltage control signal V_{g} provided by the controller 140, so as to perform a current flow switching operation to allow the harmonic components of the load-side neutral current i_{nL} to be circulated to the load 12 through the zigzag transformer 120.

The single-phase full-wave inverter circuit 111 is, for example, composed of a general H-bridge PWM inverter, as described below in detail.

The ripple-removing inductor L_{f} acts to remove switching ripples from the output terminal of the inverter circuit 111. The bypass switch 112 is normally off, but when a malfunction of the inverter circuit 111 occurs, it is turned on according to a predetermined control signal provided from the controller 140.

In this embodiment, the inverter unit 110 is composed of a single-phase full-wave inverter, and may also be composed of a known single-phase half-wave inverter.

In the zigzag transformer 120, its neutral point N is connected to the neutral line 14, three output terminals are connected to the phase lines 13a, 13b, and 13c, respectively, and first to third coil sections, each having a center tap of a predetermined division ratio, are provided between the three output terminals and the neutral point N. The first coil section of FIG. 1 is composed of three coils L1-1, L1-2, and L1-3 which are connected in series between the output terminal of the first coil section and the neutral point N. A center tap is formed at a connection node between the coils L1-1 and L1-2. Likewise, the second coil section is composed of coils L2-1, L2-2, and L2-3 connected in series, and the third coil section is composed of coils L3-1, L3-2, and L3-3 connected in series. A center tap is formed at a connection node between the coils L2-2 and L2-3, and a center tap is also formed at a connection node between the coils L3-2 and L3-3.

In this embodiment, each center tap is formed at a position where each division ratio between the coils L1-2 and L1-3, between the coils L2-2 and L2-3, and between the L3-2 and L3-3 is, for example, 0.8:0.2, which is, hereinafter, referred to as “division ratio of upper coil to lower coil”. As a DC link voltage required for removing currents of the inverter unit 110 decreases, the proportion of the coils L1-3, L2-3, and L3-3 further decreases.

In FIG. 1, the coil L1-1 of the first coil section and the coils L2-2 and L2-3 of the second coil section are parallel to each other, the coil L2-1 of the second coil section and the coils L3-2 and L3-3 of the third coil section are parallel to each other, and the coil L3-1 of the third coil section and the coils L1-2 and L1-3 of the first coil section are parallel to each other.

The zigzag transformer 120 circulates harmonic components of the neutral currents i_{nL}, provided from the neutral line 14 through neutral point N, into the load 12. The center tap of the zigzag transformer 120 is connected to each of the input terminals of the rectifier 130. This rectifier 130 rectifies AC voltage supplied from the center tap to be DC voltage. This DC voltage is supplied as a drive voltage to the inverter unit 110.

In FIG. 1, the first current sensor CS1 detects the load-side neutral current i_{nL} flowing through the neutral line 14 to output a first small signal i_{nL}′. The second current sensor CS2 detects the power-source-side neutral current iₙₛ, except a harmonic current i_{nf} flowing into the zigzag transformer, of the load-side neutral current i_{nL} to output a second small signal iₙₛ′. The first and second small signals i_{nL}′ and iₙₛ′ are extracted from the sensors CS1 and CS2 so as to have the same signal ratio as the load-side neutral current i_{nL} and the power-source neutral current iₙₛ, respectively.

In FIG. 1, the controller 140 generates a predetermined voltage control signal V_{g} for controlling a PWM operation of the inverter unit 110 based on the first and second small signals i_{nL}′ and iₙₛ′ extracted from the first and second current sensors CS1 and CS2, so that the fundamental component of the load-side neutral current i_{nL} flows to the three phase AC power sources 11a, 11b, and 11c, and its harmonic component flows to the load 12 through the zigzag transformer 120.

In such a configuration, when the load 12 is balanced, almost no current flows into the inverter unit 110 thanks to the current circulating operation of the zigzag transformer 120 and the PWM operation of the inverter unit 110. When the load 12 is unbalanced, only the zero phase component of the fundamental current, aside from the harmonic component, of the load-side neutral current i_{nL} flows into the inverter 110. Thus, it is only required for the inverter unit 110 to compensate for the zero phase component of the fundamental current, allowing a reduction of the DC drive voltage V_{d} and the current rating, compared with the prior art.

Namely, when the load 12 is balanced, the phase currents i_{La}, i_{Lb}, i_{Lc} flowing through the first to three phase lines 13a, 13b, and 13c are expressed by the following Equation 1. The load-side neutral current i_{nL}, expressed as a sum of the phase currents i_{La}, i_{Lb}, i_{Lc}, is composed of triplen-harmonic currents as its harmonic components, which is expressed by the following Equation 2. The triplen-harmonic currents all flow into the zigzag transformer 120 according to the PWM operation of the inverter 110, so that almost no current flows into the inverter unit 110.

$$\begin{matrix}{i}_{La} = {I}_{1} sin wt + {I}_{3} sin 3 wt + {I}_{5} sin 5 wt + … \\ {i}_{Lb} = {I}_{1} sin ( wt - \frac{2 π}{3} ) + {I}_{3} sin 3 ( wt - \frac{2 π}{3} ) + {I}_{5} sin 5 ( wt - \frac{2 π}{3} ) + … \\ {i}_{Lc} = {I}_{1} sin ( wt + \frac{2 π}{3} ) + {I}_{3} sin 3 ( wt + \frac{2 π}{3} ) + {I}_{5} sin 5 ( wt + \frac{2 π}{3} ) + … & [ Equation 1 ] \\ \begin{matrix}{i}_{nL} = {i}_{La} + {i}_{Lb} + {i}_{Lc} \\ = 3 [ {I}_{3} sin 3 wt + {I}_{9} sin 9 wt + {I}_{15} sin 15 wt + …\end{matrix} & [ Equation 2 ]\end{matrix}$$

When the load 12 is unbalanced, the phase currents i_{La}, i_{Lb}, i_{Lc} flowing through the first to three phase lines 13a, 13b, and 13c are expressed by the following Equation 3. While being expressed as a sum of the phase currents i_{La}, i_{Lb}, i_{Lc}, the neutral current i_{nL} is expressed as a sum of the fundamental current and its harmonic currents, as in the following Equation 3.

$${i}_{La} = {I}_{1} sin wt + {I}_{3} sin 3 wt + {I}_{5} sin 5 wt + … \\ {i}_{Lb} = {I}_{1}^{′} sin ( wt - \frac{2 π}{3} ) + {I}_{3}^{′} sin 3 ( wt - \frac{2 π}{3} ) + {I}_{5}^{′} sin 5 ( wt - \frac{2 π}{3} ) + … \\ {i}_{Lc} = {I}_{1}^{″} sin ( wt + \frac{2 π}{3} ) + {I}_{3}^{″} sin 3 ( wt + \frac{2 π}{3} ) + {I}_{5}^{″} sin 5 ( wt + \frac{2 π}{3} ) + … \qquad [ Equation 3 ]$$

Accordingly, the harmonic currents of the neutral current i_{nL} flow into the zigzag transformer 120 according to the PWM operation of the inverter unit 110, and the power-source-side neutral current iₙₛ flowing into the inverter unit 110 is composed of only zero phase components of the fundamental current, where the positive and negative phase currents are cancelled by each other, as shown in the following Equation 4. Thus, the inverter unit 110 is only required to compensate for the zero phase component of the fundamental current, which allows a reduction of the required DC drive voltage and current rating.

$$\begin{matrix}{i}_{n s} = {I}_{1} sin wt + {I}_{1}^{′} sin ( wt - \frac{2 π}{3} ) + {I}_{1}^{″} sin ( wt + \frac{2 π}{3} ) … \\ = 3 {I}_{Z} sin ( wt + Δ )\end{matrix} \qquad [ Equation 4 ]$$

(Iz: Coefficient indicating the zero phase component of the fundamental current
Δ: Phase of the zero phase component of the fundamental current)

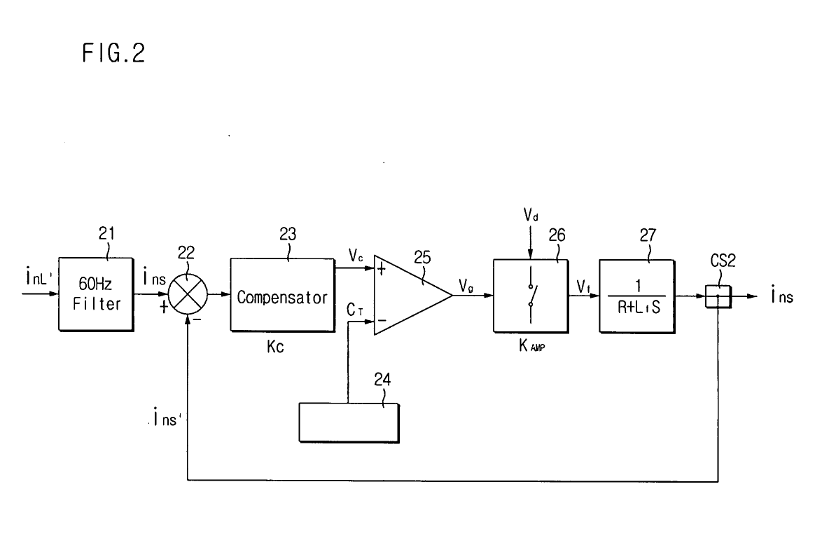

Now, the controller 140 and the inverter unit 110 of FIG. 1 are described in detail referring to FIG. 2. FIG. 2 is a functional block diagram showing the configuration of a closed-loop control system formed by the controller 140 and the inverter unit 110.

As shown in FIG. 2, the control system includes a 60 Hz filter 21, an operator 22, a compensator 23, a sinusoidal wave generator 24, a comparator 25, a switching block 26, and a passive-element block 27.

The 60 Hz filter 21 removes harmonic components of the first small signal i_{nL}′ detected by the first current sensor CS1 of FIG. 1, and then outputs it as a predetermined instruction signal iₙₛ* for controlling the inverter unit 110. The following Equation shows a transfer function of the 60 Hz filter 21.

$$G ( s ) = \frac{\frac{{ω}_{0}}{Q} s}{{S}^{2} + \frac{{ω}_{0}}{Q} s + {ω}_{0}^{2}} \qquad [ Equation 5 ]$$

Here, ω₀ denotes the angular frequency of the three phase AC power sources 13a, 13b, and 13c, and Q denotes a selectivity.

The operator 22 outputs an error signal e between the instruction signal iₙₛ* and the second small signal iₙₛ′ detected by the second current sensor CS2. The compensator 23 compensates for the error signal e with a compensation gain K_{C} and outputs a predetermined error voltage V_{C}.

The sinusoidal wave generator 21 outputs a predetermined sinusoidal wave carrier signal C_{T}, to be compared with the error voltage V_{C}. The comparator compares the error voltage V_{C} and the sinusoidal carrier signal C_{T} and outputs a voltage control signal V_{g} for controlling the PWM operation of the inverter unit 110.

As it is equivalent to the single-phase full-wave inverter circuit 111 of FIG. 1, the switching block 26 outputs a voltage signal V_{f}, whose switching gain K_{AMP} is expressed as the following Equation 6, based on the voltage control signal V_{g}.

$${K}_{AMP} = \frac{{V}_{d}}{{A}_{r}} \qquad [ Equation 6 ]$$

Here, AT denotes the maximum value of the sinusoidal carrier signal CT, and Vd denotes the DC drive voltage of the single-phase full-wave inverter circuit 111 of FIG. 1.

As it is equivalent to the ripple-removing inductor L_{f} of FIG. 1, the passive-element block removes a switching ripple from the output signal of the single-phase full-wave inverter circuit 111 to output the power-source neutral current iₙₛ.

A transfer function between the load-side neutral current i_{nL} and the power-source-side neutral current iₙs is obtained from the closed-loop control system of FIG. 2 as expressed in the following Equation 7.

$$\frac{{I}_{n s} ( s )}{{I}_{n L} ( s )} = \frac{( ( \frac{1}{Lf} \frac{ω0}{Q} {K}_{C} \cdot {K}_{AMP} ) s )}{\begin{matrix}{s}^{3} + ( \frac{R}{{L}_{f}} + \frac{{K}_{C} \cdot {K}_{AMP}}{Lf} + \frac{ω0}{Q} ) {s}^{2} + \\ ( \frac{R}{Lf} \frac{ω0}{Q} + \frac{{K}_{C} \cdot {K}_{AMP}}{Lf} \frac{ω0}{Q} + {ω}_{0}^{2} ) s + \\ ( \frac{R}{Lf} + \frac{{K}_{C} \cdot {K}_{AMP}}{Lf} ) {ω}_{0}^{2}\end{matrix}} \qquad [ Equation 7 ]$$

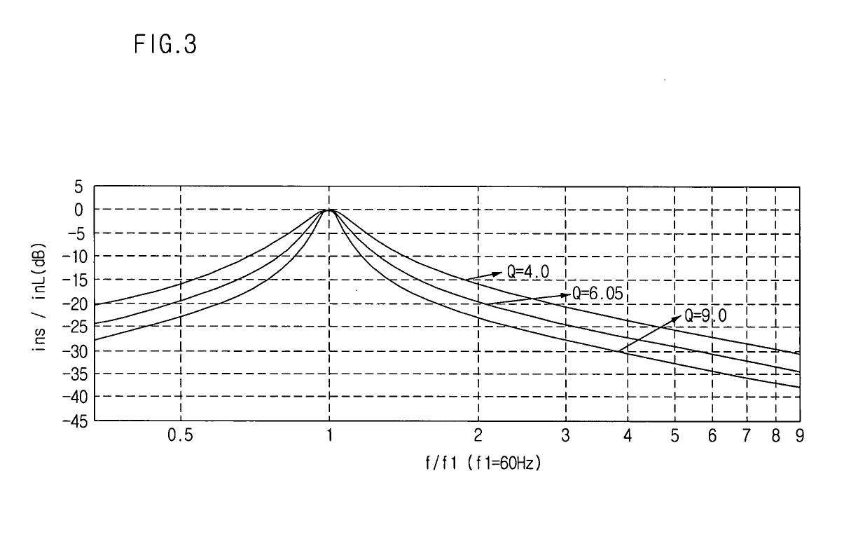

FIG. 3 shows compensation characteristics of the active power filter according to the closed-loop control system of FIG. 2 when the load is unbalanced, and the selectivity Q of the 60 Hz filter 21 is 4.0, 6.05, and 9.0, respectively. In FIG. 3, it can be seen that, irrespective of the selectivity Q of the filter, only the zero phase component (refer to Equation 4) of the fundamental current among the load-side neutral current i_{nL} flows to the three-phase AC power sources 11a, 11b and 11c, whereas the harmonic components of the load-side neutral current i_{nL} is circulated to the load through the zigzag transformer 120.

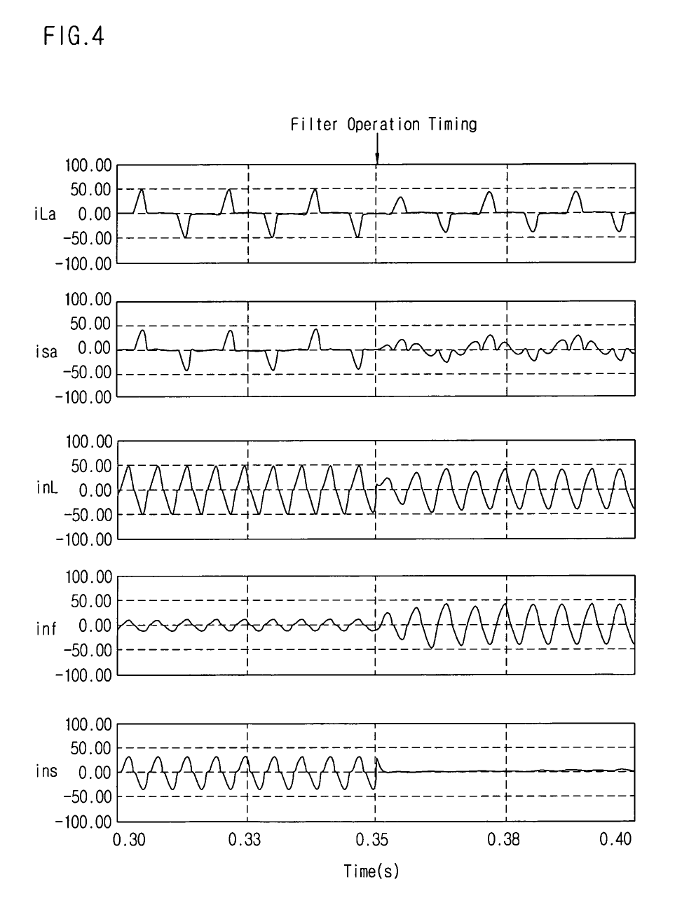

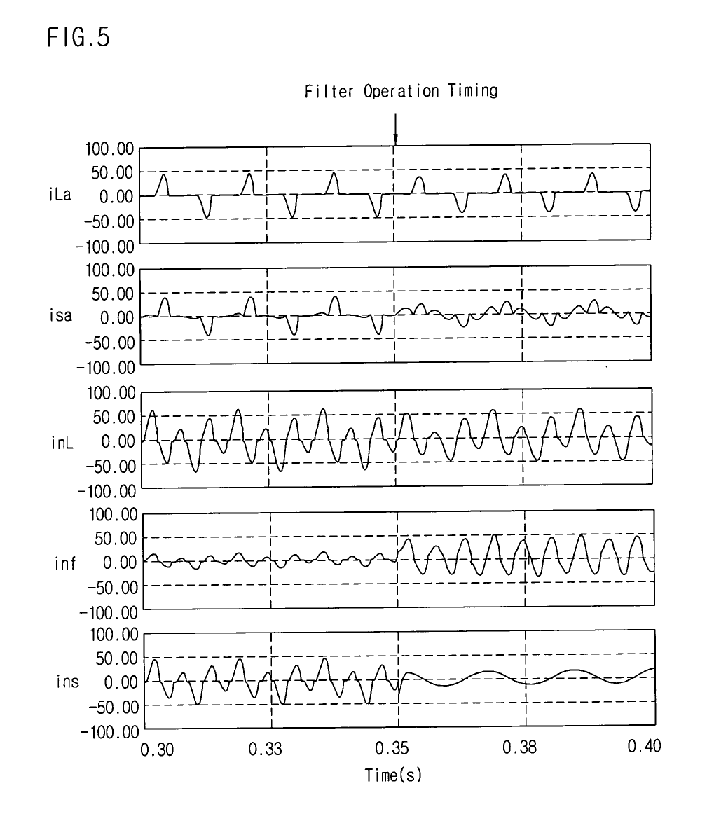

FIGS. 4 and 5 are waveforms showing simulation results of the active power filter apparatus with a reduced VA rating for reducing neutral currents, according to the embodiment of the present invention in the case where the load is balanced and unbalanced, respectively. For the sake of a simpler explanation, these figures omit i_{sb} and i_{sc} among the power-source-side phase currents iₛₐ, i_{sb}, and i_{sc}, and also omit i_{Lb} and i_{Lc} among the load-side phase currents i_{La}, i_{Lb}, and i_{Lc}.

The specifications of a system used for the simulation are shown in the following Table 2.

TABLE 2

| Power source | Phase voltage 120 V(effective value), Power |
|---|---|
| | source frequency 60 Hz, Lsa, Lsb, Lsc = 0.35 mH |
| Load | Single-phase diode rectifier having rating of |
| | 6 kVA, |
| | UBF (UnBalanced Factor) = 30% |
| Inverter | H-bridge PWM inverter, Filter inverter Lf = 1 mH, |
| | Switching Frequency 20 kHz, Drive voltage 20 V |
| Zigzag-transformer | Division ratio of upper coil to lower coil = |
| | 0.8:0.2 |

As shown in FIG. 4, excessive triplen-harmonic currents such as 3rd, 9th, 15th harmonics flow in the load-side neutral current i_{nL} even when the load 12 is balanced, because the load 12 operates by itself in a non-linear manner. The effective value of the load-side phase current i_{La} is 17.25 A, and the effective value of the load-side neutral current i_{nL} is 29.89 A which is about 1.73 times higher than the load-side phase current i_{La}.

The impedance of the AC power sources 11a, 11b, and 11c is less than the zero phase impedance of the zigzag transformer 120. Therefore, before the inverter unit 110 starts its operation (i.e., when the bypass switch 112 is switched on before the activation of the filter), most of the harmonic components of the neutral current i_{nL} flow into the power source, while a small portion thereof flows into the zigzag transformer 120. This means that the zigzag transformer 120 alone is not effective in reducing the harmonic components of the load-side neutral current i_{nL}.

However, when the inverter unit 120 operates according to the operation of the filter, most of the triplen-harmonic currents generated in the neutral line 14 are circulated to the load 12 through the zigzag transformer 120, and the power-source-side neutral current iₙₛ becomes almost zero, as shown in FIG. 4. The THD (Total Harmonic Distortion) of the load-side phase currents i_{La}, i_{Lab}, and i_{Lac} is 98.0%, but the THD of the power-source-side phase currents is iₛₐ, i_{sab}, and i_{sac} is reduced to 57.5%. This is because the triplen-harmonic components of the load-side phase currents i_{La}, i_{Lab}, and i_{Lac} and the triplen-harmonic components injected to each phase through the zigzag transformer 120 are cancelled by each other, not to appear in any of the power sources.

FIG. 5 shows waveforms of the simulation results of the active power filter when the load is unbalanced. The effective values of the load-side phase current i_{La}, i_{Lab}, and i_{Lac} are 17.25 A, 25.81 A, and 9.0 A, respectively, and the effective value of the load-side neutral current i_{nL} is 32.3 A, which includes the harmonic components and also includes the zero phase component of the fundamental current resulting from the unbalanced load.

However, when the inverter unit 120 operates according to the operation of the filter, only the zero phase component of the fundamental current among the load-side neutral current i_{nL} flow through the inverter unit 110, and the harmonic component of the load-side neutral current i_{nL} is circulated to the load 12 through the zigzag transformer 120. In this case, the result of an experiment performed by the present Applicant is that the THD of the load-side phase currents i_{La}, i_{Lb}, and i_{Lc} are 101.1%, 88.1%, and 111.7%, respectively, but the THD of the power-source phase currents is iₛₐ, i_{sab}, i_{sac} are reduced to 59.1%, 48.7%, and 110.2%, respectively, effectively reducing the harmonic components generated in the neutral line 14.

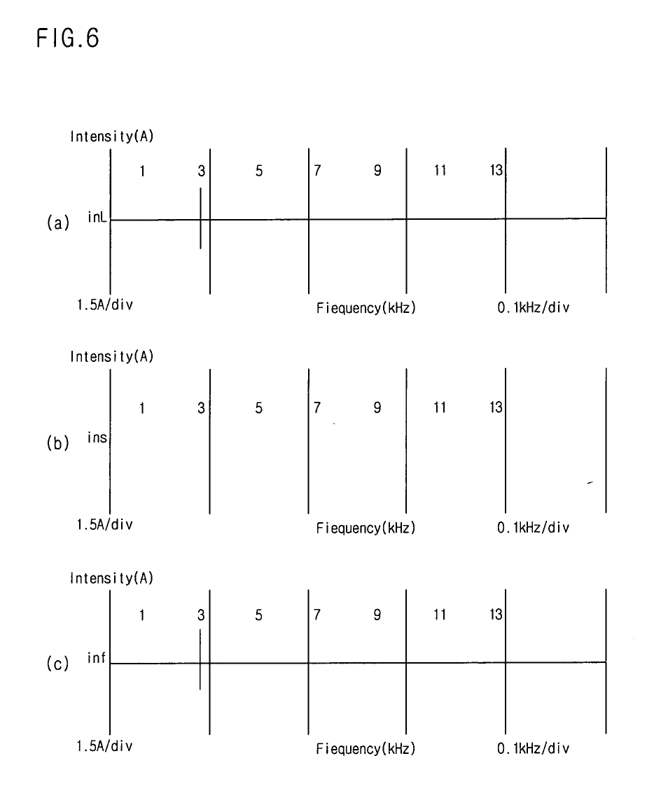

FIGS. 6a to 6c are views showing the frequency spectrum of the load-side neutral current i_{nL} (FIG. 6a), the power-source-side neutral current iₙₛ (FIG. 6b), and the harmonic current i_{nf} (FIG. 6c) to be circulated to the load 12 through the zigzag transformer 120, respectively, when the load is unbalanced (e.g., UBF=30%). In FIGS. 6a to 6c, it can be seen that the harmonic components of the currents (1, 3, 5, 7, 9, . . . ) generated in the neutral line 14 are circulated to the load through the zigzag transformer 120.

The following Table 3 shows a comparison of the internal inverter circuit's kVA rating required in an active power filter between the present invention and the third prior art (P. P. Khera, “Application of Zigzag Transformers for Reducing Harmonics in the Neutral Conductor of Low Voltage Distribution System”).

TABLE 3

| | kVA Rating (PU) of | kVA Rating (PU) of |
|---|---|---|
| UBF | Prior Art | Present Invention |
| 0% | 1 | 0 |
| 10% | 1.05 | 0.04 |
| 30% | 1.27 | 0.11 |
| 50% | 1.62 | 0.17 |

The data in the Table 3 are obtained under the assumption that the inverter's kVA rating is 1 pu when the load is balanced. From this Table, it can be seen that the inverter's kVA rating in the present invention is very low compared to the prior art. Particularly, when the load 12 is balanced, the power-source-side neutral current iₙₛ is almost 0, thereby achieving the inverter's ideal kVA rating of 0.

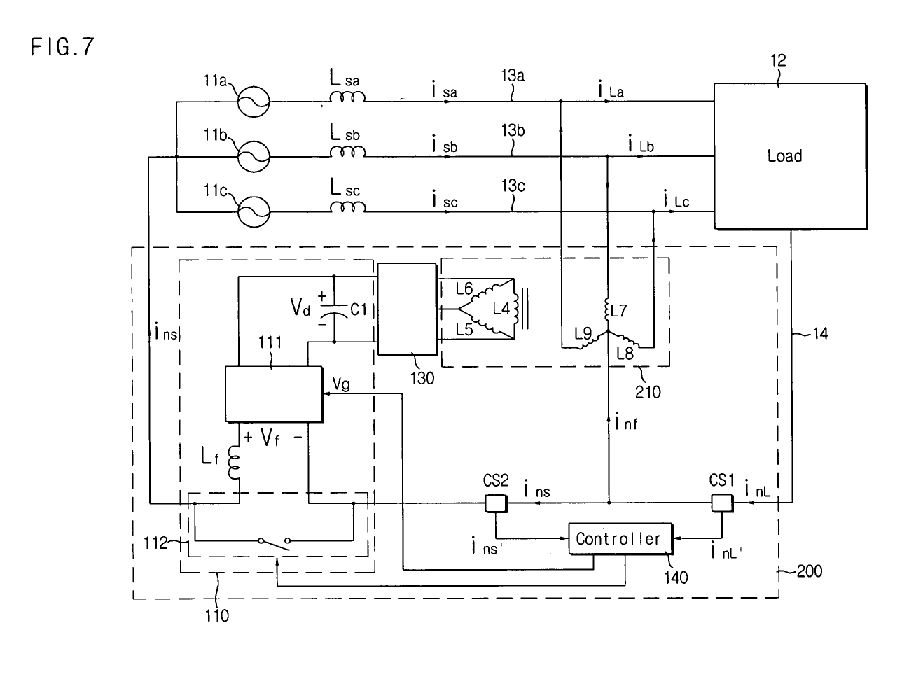

FIG. 7 is a view showing the circuit configuration of an active power filter device with a reduced VA rating for removing neutral currents, according to another embodiment of the present invention. The same elements as those in FIG. 1 are denoted by the same reference numerals or symbols in FIG. 7, and their detailed description will be omitted.

In this embodiment, as shown in FIG. 7, the zigzag transformer 120 of FIG. 1 is replaced with a general A-Y transformer 210 composed of a number of coils L4 to L10. The same phase currents flow in the coils L4 and L7, and the same phase currents flow in the coils L5 and L8. Also, the same phase currents flow in the coils L6 and L9. The active power filter of FIG. 7 has the same operation and advantages as that of FIG. 1, and thus its detailed description is omitted.

As mentioned above, in the active power filter according to the present invention, the harmonic component occurring in the neutral line is effectively removed. In addition, only the fundamental current due to the unbalanced load flows through the internal inverter circuit. Therefore, the required inverter's current rating is lowered, compared to the active power filter in the prior art in which all triplen-harmonic currents flow through the inverter circuit. Moreover, even when the load is unbalanced, it is only required to compensate for the zero phase component of the fundamental current, and thus the required DC drive voltage in the internal inverter circuit is significantly lowered compared to the active power filter in the prior art in which it is also required to compensate for the triplen-harmonic current.

### INDUSTRIAL APPLICABILITY

As apparent from the above description, according to the present invention, harmonic currents generated in a neutral line can be easily removed while not being affected by the system impedance, and, even when unbalanced loads are employed, the internal inverter is only required to compensate for the fundamental zero-phase current, which allows a significant reduction of the inverter's VA rating with respect to the load capacity.

In addition, the present invention permits removal of the harmonic component of the power-source-side phase current, as well as removal of the harmonic component of the neutral current, thereby improving the THD of the power-source-side phase current. As a result, the present invention can provide a low-priced active power filter for removing neutral currents generated in a three-phase four-line power distribution system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An active power filter apparatus with a reduced VA rating for reducing harmonic currents generated in a neutral line connected between a load and a three-phase AC power source in a three-phase four-line power distribution system, the apparatus comprising:
an inverter unit connected in series with the neutral line for controlling current flow of the neutral line based on a predetermined voltage control signal so that a fundamental component of a load-side neutral current flows to the three-phase AC power source and a harmonic component of the load-side neutral current is circulated to the load;
a transformer connected between the neutral line and each phase line of the three-phase AC power source for forming a current path which allows the harmonic component of the load-side neutral current to flow to the load through the phase line;
a rectifier unit connected between the transformer and the inverter unit for rectifying a predetermined drive voltage, supplied to the transformer, into a DC voltage and applying the rectified DC voltage to the inverter unit; and
a controller for generating the voltage control signal for use in controlling a PWM operation of the inverter unit based on a first small signal of the load-side neutral current and a second small signal of the power-source-side neutral current, which are extracted from the neutral line.

2. The apparatus as set forth in claim 1, wherein the transformer includes first to third coil sections, a neutral point of the first to third sections being connected to the neutral line, each output terminal of the first to third coil sections being connected to each corresponding phase line, a center tap having a predetermined division ratio being formed between the neutral point and each output terminal and being connected to a corresponding input terminal of the rectifier unit.

3. The apparatus as set forth in claim 2, wherein each center tap is formed at a position where a division ratio of an upper coil to a lower coil in each of the first to third coil sections is 1−X:X, said X being equal to or less than 0.5.

4. The apparatus as set forth in claim 1, wherein the transformer is a Δ-Y transformer.

5. The apparatus as set forth in claim 1, wherein a first current sensor for extracting the first small signal from the load-side neutral current and a second current sensor for extracting the second small signal from the power-source-side current are connected in series on the neutral line, and
wherein the controller receives the first and second small signal from the first and second current sensors.

6. The apparatus as set forth in claim 1, wherein the inverter includes:
a smoothing capacitor for charging itself with a predetermined DC drive power received through the rectifier;
a single-phase full-wave inverter circuit for performing a PWM operation according to the voltage control signal provided from the controller so as to perform a current-flow switching control so that the harmonic component of the load-side neutral current is circulated to the load through the transformer;
a ripple-removing inductor connected to the output terminal of the single-phase full-wave inverter circuit for removing a switching ripple; and
a bypass switch which is switched off during a normal operation of the single-phase full-wave inverter circuit and switched on according to a predetermined control signal provided from the controller when a malfunction of the single-phase full-wave inverter circuit occurs.

7. The apparatus as set forth in claim 1, wherein the inverter unit is a single-phase half-wave inverter.
